(19) United States
(12) Patent Application Publication
(10) Pub. No.: US 2007/0125942 A1
(43) Pub. Date: Jun. 7, 2007

(54) Apparatuses, systems and methods for isolating and separating biological materials

(75) Inventor: Horacio Kido, Niland, CA (US)

Correspondence Address: BUCHANAN, INGERSOLL & ROONEY LLP, P.O. BOX 1404, ALEXANDRIA, VA, 22313-1404, US

(73) Assignee: The Regents of the University of California, Oakland, CA (US)

(21) Appl. No.: 11/483,071

(22) Filed: Jul. 6, 2006

Related U.S. Application Data
(60) Provisional application No. 60/697,056, filed on Jul. 6, 2005.
(60) Provisional application No. 60/791,855, filed on Apr. 12, 2006.

(51) Int. Cl. B01D 59/44

(52) U.S. Cl. 250/284

(57) ABSTRACT

This invention relates to apparatuses, systems and methods for disrupting, separating and isolating biological materials and components thereof.

### CROSS REFERENCE TO RELATED APPLICATIONS

This application claims priority to U.S. Provisional Application Ser. No. 60/697,056 filed Jul. 6, 2005, and to U.S. Provisional Application Ser. No. 60/791,855 filed Apr. 12, 2006, the disclosures of which are incorporated herein by reference.

### STATEMENT REGARDING FEDERALLY SPONSORED RESEARCH

This invention was supported in part by Grant No. 482530-78185 awarded by the National Institute of Health. The government may have certain rights in this invention.

### TECHNICAL FIELD

This invention relates to apparatuses, systems and methods for the disruption and preparation of biological samples.

### BACKGROUND

The disruption of cells or viruses to release their contents is an important part of preparing samples for subsequent molecular biology or diagnostics applications. Important components released include proteins, nucleic acids, hormones, lectins, etc. Nucleic acids are especially important targets for genetic analysis purposes utilizing polynucleotide amplification reactions such as polymerase chain reaction (PCR) and ligase chain reaction.

Current methods for extracting nucleic acids are either chemical or mechanical in nature. The chemical methods typically involve the use of a combination of caustic agents, detergents, enzymes, and/or organic solvents to disrupt cells or viruses. This approach necessitates the use of subsequent steps to adjust pH and wash the nucleic acids to remove chemicals that may interfere with molecular techniques such as PCR. These necessary steps add cost and time to the extraction process, and reduce the yield of nucleic acids.

Mechanical methods of cell and virus disruption do not have the same drawbacks as chemical methods but do have different ones. For example, one physical approach involves heating a sample of cells to release nucleic acids. The problem with this method is that proteins denatured by the heat can non-specifically attach themselves to nucleic acids and interfere with PCR. Another physical method of disrupting cells and viruses is the expose them to multiples cycles of freezing and thawing. The problem with this method is that it does not disrupt some of the toughest spores and viruses. Mycobacteria may be disrupted by a forcing them under high pressure through small diameter pores of a substrate. However this method requires expensive equipment for generating high pressures as well as for dissipating the heat generated. Because of the nature of the equipment, it is prone to cause cross-contamination problems unless properly cleaned between samples. The heat generated can also damage the contents of the cells being disrupted. The application of ultrasonic energy to a sample is another physical method of cell or virus disruption. One common embodiment of this approach is an ultrasonic bath into which one may dip a container with the sample to be disrupted. The main problem with this method is that energy is not distributed evenly in the bath and thus careful placement of the sample within the bath is necessary. In addition, the energy is low in density within the bath so that long incubation times are necessary for thorough cell or virus disruption to take place.

Accordingly, reproducible and cost-effective apparatuses, systems and methods for isolating biological components from biological materials are needed.

### SUMMARY

Provided herein are novel apparatuses, systems and methods for isolating biological components from biological materials. In some embodiments, an apparatus of the invention includes a separation unit having: a) an inlet for receipt of a biological sample; b) a first chamber coupled to the inlet, the first chamber including at least one translocatable member that translocates in response to a fluctuating magnetic field; c) a second chamber disposed adjacent to, and in fluidic communication with, the first chamber; d) a third chamber adjacent to, and in fluidic communication with, the second chamber; and e) an outlet coupled to the third chamber. In other embodiments, the first, second, or third chamber optionally includes a ventilation port. In general, the translocatable member that translocates in response to a fluctuating magnetic field includes paramagnetic material. The member can be in the shape of a disk.

In other embodiments, the first chamber of an apparatus of the invention further includes at least one object that does not translocate in response to a fluctuating magnetic field. The object can be a bead, such as a glass bead or a plastic bead.

In general the first chamber and second chamber are connected by a channel, which can be constricted. The first chamber can be a milling chamber and the second chamber a clarification chamber. The third chamber can be a collection chamber. The first, second, or third chamber optionally includes at least one affinity region comprising an affinity matrix which can have an affinity to nucleic acids. Further, the first, second, or third chamber optionally includes reagents sufficient to amplify nucleic acids in the biological material.

In another embodiment, a system that includes an apparatus of the invention is provided. The system further includes a platform operably associated with the apparatus; an element that induces a magnetic field in proximity to the apparatus associated with the platform; and a mechanism for periodically or continuously fluctuating the magnetic field in proximity to the apparatus associated with the platform. In some aspects, fluctuating the magnetic field includes repositioning the apparatus in relation to the element that induces a magnetic field. In other aspects, fluctuating the magnetic field includes repositioning the element that induces a magnetic field in relation to the apparatus.

The platform can include multiple layers of polycarbonate material. In addition, the platform can be detachably or permanently associated with the apparatus. Further, a system provided herein can be associated with a programmable computer suitable for automating some or all of the activities associated with the system.

In yet another embodiment, a method for separating components of a biological material is provided. The method includes: a) introducing a sample containing a starting biological material in to a first chamber of an apparatus. The first chamber includes at least one translocatable member that translocates in response to a fluctuating magnetic field; b) applying a fluctuating magnetic field to the apparatus, wherein the translocatable member is repositioned in the first chamber resulting in the separation of biological material in to biological components; c) transferring at least a portion of the biological components to a second chamber of the apparatus; and d) isolating the biological components. Biological materials suitable for use in the present apparatuses, systems and methods include, but are not limited to, cells, viral particles, and/or tissue.

The method further includes separating the biological components in to biological constituents.

In another embodiment, a system for facilitating sample disruption is provided. The system includes at least one removable chamber including a paramagnetic object. In general the removable chamber is detachably connected to a chamber adapter configured to confine the removable chamber. The system further includes a mechanism for generating a stationary magnetic field and a mechanism for translocating the removable chamber within the stationary magnetic field. The mechanism is operably associated with the chamber adapter configured to confine the removable chamber. In some aspects, the removable chamber includes a microcentrifuge tube.

In some embodiments, the system further includes a rotor assembly that includes fasteners configured to detachably restrain an assembly comprising the removable chamber adapter and the removable chamber. In other embodiments, the system further includes a terminal adapter operably associated with a mechanism for translocating the chamber.

The details of one or more embodiments of the disclosure are set forth in the accompanying drawings and the description below. Other features, objects, and advantages will be apparent from the description and drawings, and from the claims.

### BRIEF DESCRIPTION OF DRAWINGS

FIG. 1 depicts an exemplary apparatus for sample purification.

FIG. 2 depicts an expanded view of an exemplary apparatus for sample purification.

FIG. 3 depicts an expanded view of a rotor assembly that includes 12 independent separation units.

FIG. 4 depicts an exemplary magnetic field produced by the arrangement of 6 cylindrical magnets.

FIG. 5 provides a transparent view of a section of rotor 18 comprising separation units rotating over a stationary magnet holder.

FIG. 6 is a table containing exemplary rotation rates and times that can be used in the operation of an apparatus for milling and purification of a sample.

FIG. 7, panels A, B, C, and D depict functional units associated with an exemplary apparatus for milling and purification of a sample.

FIG. 8 depicts a separation unit that includes an expanded inlet port and additional chambers.

FIG. 9 depicts an exemplary apparatus from sample purification.

FIG. 10 depicts an expanded view of components associated with an apparatus depicted in FIG. 9.

FIG. 11 depicts an enlarged view of an exemplary rotor assembly.

FIG. 12 depicts an exemplary magnetic field generated by magnets 62A and 62B as shown in FIG. 10.

FIG. 13 depicts a transparent representation of the rotor assembly shown in FIG. 11.

FIG. 14A depicts a top view of 6 separation units associated with the rotor assembly shown in FIG. 11. A single separation unit is circled.

FIG. 14B depicts an exemplary separation unit.

FIG. 15 depicts an exemplary apparatus for oscillating a translocatable member, such as a paramagnetic object, associated with separation units included in multiple rotors.

FIG. 16 depicts an expanded view of the apparatus of FIG. 15.

FIG. 17, panel A, B, C, and D depict a sequence of positions of a translocatable member within a chamber associated with a separation unit included in a rotor assembly.

FIG. 18 depicts an exemplary separation unit that incorporates and in-line filter.

Like reference symbols in the various drawings indicate like elements.

### DETAILED DESCRIPTION

The present invention provides an apparatus, system and methods for the efficient treatment of biological samples, such as cell cultures, whole blood cell samples, serum, urine, saliva, tissue, and samples containing viral particles. The treatment includes preparing component biological materials, such as purified cellular components, DNA, or RNA, from the sample biological material.

While microfluidic technology fucuses on picoliter, nanoliter, and microliter fluid volumes, for some diagnostic applications these small volumes are not practical. The full range of chemical concentrations which one may want to detect in biological samples spans at least 20 orders of magnitude (from 6 copies/mL to 6×10²⁰ copies/mL). Accordingly, apparatuses, systems and methods for isolating potential analytes which can exist in very low concentrations in some biological samples (e.g., nucleic acids) should be capable of processing large as well as small sample volumes.

The detection of low copy concentrations of analytes such as DNA may require the lysis, clarification and purification of large sample volumes. For example, the minimum theoretically detectable concentration for DNA probe assays necessitates large sample sizes, such as about 10-4 liters or more. In detecting infectious diseases, gram negative bacteria can be present at less than 10 copies per ml of blood, cryptosporidium generally appears as only a few copies per gallon of drinking water, concentrated biothreat agents, e.g. anthrax, at less than 100 copies per ml of water, and food poisoning agents, such as E. coli and salmonella, may be manifested in less than 10 copies per gram of food.

The apparatuses and methodology provided herein facilitate processing of large and small sample volumes by utilizing scalable separating units having any desired combination of microscale to macroscale channels, chambers, reservoirs, and processing regions. A plurality of separating units can be incorporated in to a platform suitable for simultaneously processing multiple samples without user intervention. A platform including separation units provides an apparatus for separating a desired analyte from a fluid sample and for concentrating the analyte into a volume of elution fluid smaller than the original sample volume is provided. The desired analyte may comprise, e.g., organisms, cells, proteins, nucleic acid, carbohydrates, virus particles, bacterias, chemicals, or biochemicals. The apparatus can include flow controller, e.g., one or more valves, flow diverters, or fluid diodes, for directing the fluid sample into a desired flow path and for directing elution fluid and/or eluted analytes into a particular flow path.

The apparatus includes a separation unit having formed therein an inlet port for introducing the sample into the unit and a sample flow path extending from the inlet port to a milling chamber. The milling chamber includes a translocatable member configured to move within the chamber and disrupt particles, such as cells or viruses, contained in the chamber. In general the translocatable member is comprised of paramagnetic material. The milling chamber is fluidly connected to additional chambers, ports and channels that further facilitate the processing of the sample material containing a target analyte. For example, the separation unit can include a collection chamber for collecting clarified sample from a milling chamber. The collection chamber can include a collection port for removal of the clarified sample. However, in some embodiments the collection chamber can include additional reagents for further isolation of a target analyte. Further isolation of the target analyte can include purification and/or amplification of the analyte. Accordingly, the collection chamber can include reagents for capturing and/or amplifying an analyte. In other embodiments, the collection chamber can be fluidly connected to one or more chambers for further processing of the clarified sample.

Accordingly, apparatuses, systems and methods for the milling/purification of tissue, cells or viral particles and separation of component materials are provided. In one embodiment, an apparatus includes a separation unit that includes multiple chambers for milling and separating components of a biological sample. In one implementation, the separation unit includes a first chamber and a second chamber, the first and second chambers being coupled through a channel. Transport between the first chamber and second chamber may be bidirectional or unidirectional. Various modes of transport may be utilized in conjunction with the transport of component materials between the first and second chamber.

The flow of material through the channel may be controlled by centrifugal force, gravity, or by an electrode operably associated with channel. The electrode may be formed, for example, adjacent to and circumferentially surrounding the channel. The electrode may be disposed so as to receive a signal generating a repulsive force to charged components comprising the material thereby providing an electrophoretic motion through the channel.

The chambers may include various materials within them. For example, the first chamber (e.g., the “milling” chamber) may include one or more translocatable members that translocate within the chamber in response to a fluctuating magnetic field (e.g., paramagnetic objects). Additional materials that may be included in the chamber include objects that do not translocate in response to a fluctuating magnetic field. Such objects include those that increase the shearing force of the translocatable member. Exemplary objects include glass or plastic beads. Affinity or other filter materials may be included within the chambers to facilitate the separation of the materials in to isolatable components.

Various functions can be performed in different chambers. By segregation of various functions, typically disruption, separation/purification and/or analysis functions, processes may be optimized for those functions. In one embodiment, a first chamber can be adapted for disruption of the starting biological material, such as cells or viral particles, in to biological components that comprise the starting sample. A second chamber can be adapted for separating the biological components derived from the sample, which are obtained at least in part from the first chamber. In general, the sample will contain a target analyte. A third chamber can be adapted for collection of the separated biological components, which are obtained at least in part from the second chamber. Optionally, the second or third chamber may include mechanisms for analysis of the separated biological components containing a target analyte.

After the step of disruption of tissues and/or cell lysis, further steps can be carried out by a separation unit associated with an apparatus provided herein for the purification, isolation and/or detection of an analyte of interest. Such analytes include nucleic acids, polypeptides, bacteria, virus, antigens, and the like. Methods known in the art may be applied for the purification, isolation and detection of an analyte. For example, in case of purification and isolation of nucleic acids, immunomagnetic capture beads, or beads coated with at least one linker comprising polyT-oligos or a linker complementary for a particular sequence of a specific nucleic acid may be present in a chamber, such as the first or second chamber. The nucleic acid can then be recovered by using a magnet to trap the beads, washing out, and finally recovering the nucleic acids bound to the beads.

With regard to the separation unit, the first, second and third chambers are in fluidic communication via channels. Additional chambers may be disposed in proximity to the first, second, and/or third chambers. The additional chambers are generally in fluid communication with the chambers. The additional chambers may be used, for example, as reservoirs that contain reagents useful for the disruption, detection and/or storage of component biological materials. The chambers optionally include inlet ports, outlet ports and/or ventilation ports that facilitate the addition, translocation and/or extraction of a starting material (e.g., cells, viral particles, etc.).

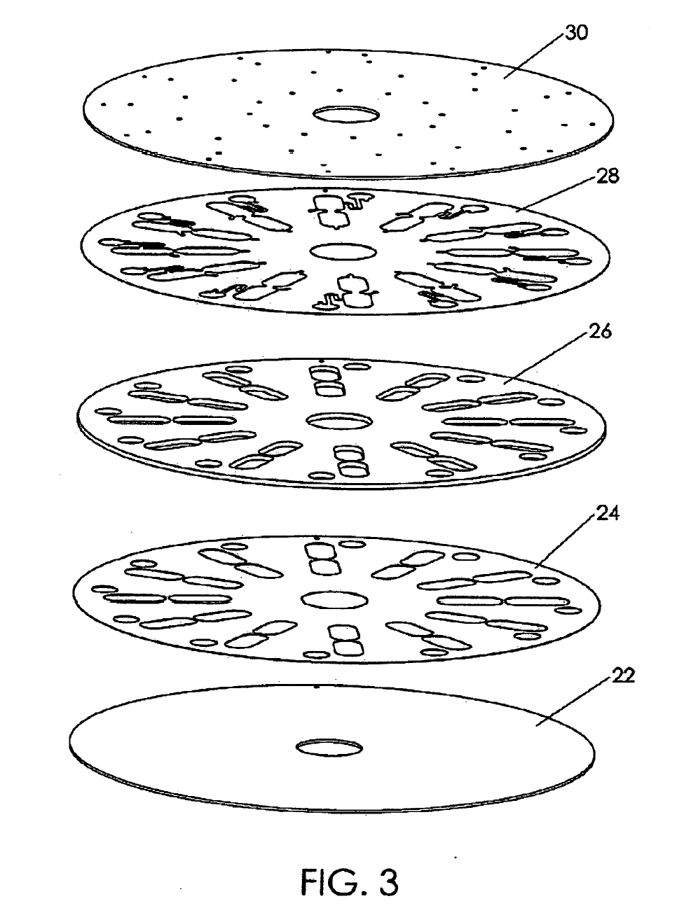

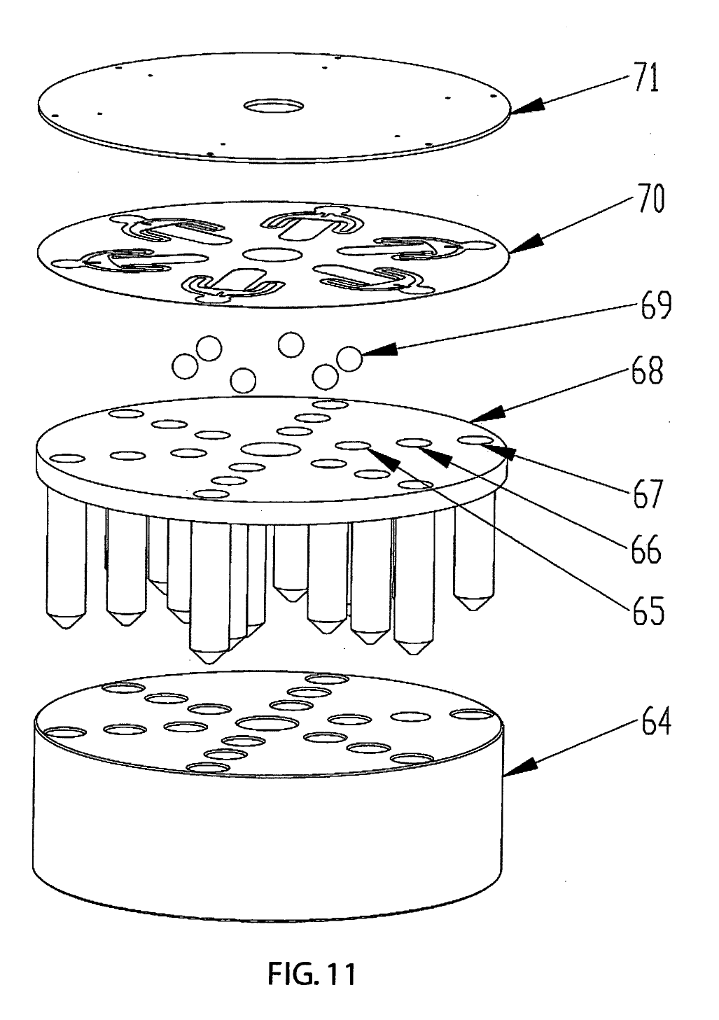

As used herein, an apparatus includes at least one separation unit operably associated with a platform. In general, a platform provides structures suitable for the association of multiple separation units. A platform provides a base structure from which at least one, and optionally multiple, separation units are disposed. An exemplary platform is shown in FIG. 3. The platform includes bottom disk 22, bottom cut adhesive 24, middle disk 26, top cut adhesive 28, and top disk 30. Another example of a platform comprising separation unit(s) is shown in FIG. 11. In this example the platform includes rotor 64, insert 68, patterned layer 70, and cover 71. In this example patterned layer 70 delineates multiple separation units in the x and y dimension. However, it is understood that the chambers included in insert 68 (e.g., chambers 65, 66 and 67) are operably associated with, and considered part of, their respective separation units. Thus, in this example a separation unit includes structures in the z dimension that may not be readily apparent from the patterned layer 70.

A platform comprising separation unit(s) may be fabricated using one or more of a variety of methods and materials suitable for microfabrication techniques. For example, the platform may comprise a number of planar members that may individually be sheets or injection molded parts fabricated from a variety of polymeric materials, or may be silicon, glass, or the like. In the case of substrates like silica, glass or silicon, methods for etching, milling, drilling, etc., may be used to produce wells and depressions which make up the various regions, chambers and fluid channels associated with a separation unit.

The overall geometry of the separation unit may take a number of forms. For example, the unit may incorporate a plurality of interactive regions, e.g. channels or chambers, and storage regions, arranged in series, so that a fluid sample is moved serially through the regions, and the respective operations performed in these regions. Generally, a single separation unit includes at least two distinct chambers, and optionally, at least three or more distinct chambers. Individual chambers may vary in size and shape according to the specific function of the chamber. In some cases, elongated or spherical chambers may be employed. In general, the chambers, inlets, ports and channels may vary in dimensions from microscale (microns) to mesoscale (submillimeters) to macroscale (millimeters).

In yet another aspect of this invention, a system is provided for performing disruption and separation of biological materials. Such a system would include an apparatus of the invention operably associated with a mechanism for manipulating the apparatus in, for example, a magnetic field. Thus, a system can further include elements capable of forming a magnetic field in proximity to an apparatus comprising a platform associated with separation unit(s). A magnetic field formed by such elements contacts the translocatable members that translocate within a first chamber associated with a separation unit in response to a fluctuating magnetic field. The contacting results in the movement of the translocatable member within the first chamber. The movement facilitates the disruption of the starting biological materials associated with the first chamber.

In the examples provided herein, the apparatus is generally repositioned in a magnetic field established by multiple, fixed magnetic elements. However, it is understood that the application of a fluctuating magnetic field to an apparatus of the invention can be accomplished in any manner known to those skilled in the art. A fluctuating magnetic field can be established using an electric field or permanent magnetic elements. For example, electro or permanent magnetic elements can be disposed above, below, or to the side, or any combination thereof, of an apparatus of the invention. The geometry of the magnetic field need only be positioned to facilitate the movement of the translocatable members that translocate within the first chamber in response to a fluctuating magnetic field.

For example, the position of the magnets forming the magnetic field can be fixed while an apparatus, or multiple apparatuses, is periodically or continuously repositioned within the magnetic field. The repositioning of the apparatus within the field causes the magnetic field to fluctuate in proximity to the apparatus. In another embodiment, the position of the apparatus, or multiple apparatuses, can be fixed while the magnets forming the magnetic field are periodically or continuously repositioned in proximity to the apparatus. In this embodiment, the repositioning of the magnets causes the magnetic field to fluctuate in proximity to the stationary apparatus. In yet another embodiment the magnetic elements forming the magnetic field, and an apparatus, can all be in motion in proximity to one another in order to facilitate a fluctuating magnetic field. In yet another embodiment, the magnetic elements forming the magnetic field, and the apparatus, can all be in a fixed position in proximity to one another. In this embodiment a fluctuating magnetic field can be established by alternating the electric current between electromagnetic elements.

A system can further include a mechanism for rotating the apparatus through a magnetic field established by fixed magnetic elements. As noted above, it is understood that the apparatus can remain fixed while magnetic elements are repositioned around the apparatus. In those embodiments where the apparatus is repositioned in the magnetic field, it is also understood that the apparatus can be repositioned rotationally, linearly, elliptically, or in any other manner consistent with the movement of the translocatable members that translocate within the first chamber in response to a fluctuating magnetic field.

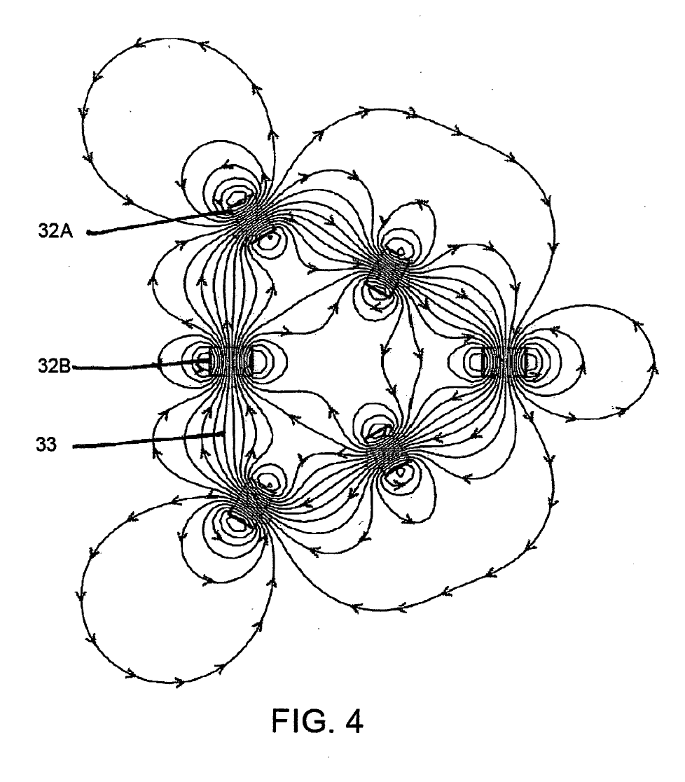

Accordingly, elements of a system of the invention, e.g., a mechanism for establishing a magnetic field and an apparatus of the invention, need only be configured so as to facilitate an interaction between the magnetic field and an apparatus. As used herein, the term “configured” is defined as the amount and geometry of the system elements organized so as to function in accordance with the role of the elements in a system of the invention. For example, a magnetic element is “configured” for operating in a system of the invention by positioning the element in proximity to an apparatus of the invention. The configuration (e.g., amount and/or geometry) of the magnetic field established by a magnetic element may be impacted (i.e., modified) by the quantity and size of magnetic elements and their proximity to an apparatus associated with a platform. As used herein, the term “proximity” means that one element in a system is near enough to another element in the system such that each element can impact or modify the function of the other element. This is exemplified in the diagram of magnetic flux lines provided in FIG. 4.

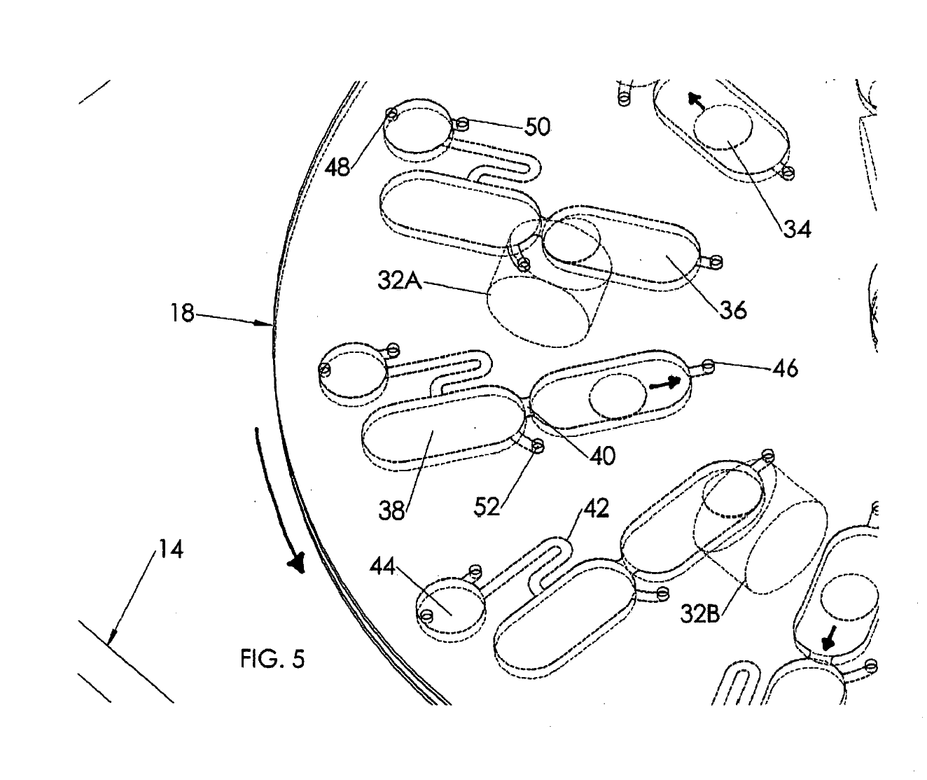

The movement of biological material, in suspension or in solution, from one chamber to another can be facilitated by centrifugal force, electromechanical force, electrical force, or any other mechanism for moving charged and/or uncharged molecules from one chamber to another in a liquid environment. For example, once biological material, such as a cell, is disrupted in a first chamber of separation unit associated with an apparatus, the apparatus can be rotated at a speed sufficient to move biological components through a channel in to a second chamber (see e.g., FIG. 5). Once in the second chamber the biological components can be separated in the second chamber by rotating the apparatus at speed sufficient to further separate biological components. Separated biological components can then be transferred to a third chamber for storage or for analysis.

Chambers associated with a separation unit can include reagents for capturing and/or amplifying a target analyte. It is understood that reagents may be exogenously introduced into a chamber associated with a separation unit before use, e.g., through sealable openings in each region of the separation unit. Alternatively, the reagents may be placed in the separation unit during manufacture. The reagents may be disposed within the regions that perform the operations for which the reagents will be used, or within regions leading to a particular region. Alternatively, the reagents may be disposed within storage/auxiliary chambers in fluid communication with other chambers. The type of reagent utilized in a chamber depends, inter alia, on the fluid characteristics and size of the sample, the nature and concentration of the target constituents, and the desired processing protocol. In the case of solution phase interactions, the reagents may be aqueous solutions or dried reagents requiring reconstitution. The particular format is selected based on a variety of parameters, including whether the interaction is solution-phase or solid-phase, the inherent thermal stability of the reagent, speed of reconstitution, and reaction kinetics.

Liquid reagents may include, but are not limited to, buffer solutions such as saline, TRIS, acids, bases, detergent solutions, and chaotropic solutions, which are commonly used for DNA and RNA purification and washing. Dried reagents can be employed as precursor materials for reconstitution and solution-phase interaction or as solid-phase reagents, including pH indicators; redox indicators; enzymes such as horseradish peroxidase, alkaline phosphatase, reverse transciptase, DNA polymerase, and restriction enzymes; enzyme substrates; enzyme-antibody or enzyme-antigen conjugates; DNA primers and probes; buffer salts; and detergents. Furthermore, solid-phase reagent coatings such as serum albumin, streptavidin, and a variety of cross-linkable proteins such as polysaccharides may be employed at the interactive region.

Dried reagents may also be contained within a membrane material that can be employed by physical incorporation of the material into a chamber in communication with fluidic channels. Cellulose, nitrocellulose, polycarbonate, nylon, and other materials commonly used as membrane materials can be made to contain reagents. Such membranes are designed to capture target cells, effect lysis of host cells, release target nucleic acids, and separate contaminants that may interfere with the polymerase chain reaction (PCR) or other analytical events. Suitable reagents are discussed in more detail below.

Capture reagents generally include chemical and/or structural reagent(s) suitable for purification of a particular analyte. In general, the composition of a capture reagent will depend generally on the composition of the analyte targeted for isolation. Reagents suitable for use in various purification protocols are discussed in more detail below. A chamber modified to include reagents for the capture and/or amplification of an analyte can be configured to include microstructures that support, or are otherwise associated with, the reagents. The microstructures are generally configured to have sufficiently high surface area and binding affinity with the desired analyte to capture the analyte as the sample flows through the chamber. For example, the microstructures can comprise an array of columns integrally formed with the wall of the chamber and extending into the chamber. Alternatively, the chamber can contain a solid support for capturing the analyte. Suitable solid supports include, e.g., filters, beads, fibers, membranes, glass wool, filter paper, polymers and gels. It is understood that capture reagents include those reagents that capture non-target analytes and allow the target analytes to be collected in another chamber. Accordingly, capture reagents are understood to encompass any reagent that facilitates the separation of target analytes from non-target analytes.

Reagents for separating analytes can include extraction media in the form of water-insoluble particles (e.g, a porous or non-porous bead) that have an affinity for an analyte of interest. Typically the analyte of interest is a nucleic acid, protein or peptide. The extraction processes can be affinity, size exclusion, reverse phase, normal phase, ion exchange, hydrophobic interaction chromatography, or hydrophilic interaction chromatography agents. In general, the term “extraction media” is used in a broad sense to encompass any media capable of effecting separation, either partial or complete, of one analyte from another. The term “analyte” can refer to any compound of interest, e.g., to be analyzed or simply removed from a solution.

Extraction chemistry can take any of a wide variety of forms. For example, the extraction media can be selected from, or based on, any of the extraction chemistries used in solid-phase extraction and/or chromatography, e.g., reverse-phase, normal phase, hydrophobic interaction, hydrophilic interaction, ion-exchange, thiophilic separation, hydrophobic charge induction or affinity binding. Because apparatuses and methods described herein are particularly suited to the purification and/or concentration of biomolecules, extraction surfaces capable of adsorbing such molecules are particularly relevant. See, e.g., SEPARATION AND SCIENCE TECHNOLOGY Vol. 2.:HANDBOOK OF BIOSEPARATIONS, edited by Satinder Ahuja, Academic Press (2000).

Affinity extractions use a technique in which a biospecific adsorbent is prepared by coupling a specific ligand (such as an enzyme, antigen, or hormone) for the analyte, (e.g., macromolecule) of interest to a solid support. This immobilized ligand will interact selectively with molecules that can bind to it. Molecules that will not bind elute unretained. The interaction is selective and reversible. The references listed below show examples of the types of affinity groups that can be employed in the practice of this invention are hereby incorporated by reference herein in their entireties. Antibody Purification Handbook, Amersham Biosciences, Edition AB, 18-1037-46 (2002); Protein Purification Handbook, Amersham Biosciences, Edition AC, 18-1132-29 (2001); Affinity Chromatography Principles and Methods, Amersham Pharmacia Biotech, Edition AC, 18-1022-29 (2001); The Recombinant Protein Handbook, Amersham Pharmacia Biotech, Edition AB, 18-1142-75 (2002); and Protein Purification: Principles, High Resolution Methods, and Applications, Jan-Christen Janson (Editor), Lars G. Ryden (Editor), Wiley, John & Sons, Incorporated (1989).

U.S. patent application Ser. No. 10/622,155 describes in detail the use of specific affinity binding reagents in solid-phase extraction. Examples of specific affinity binding agents include proteins having an affinity for antibodies, Fc regions and/or Fab regions such as Protein G, Protein A, Protein A/G, and Protein L; chelated metals such as metal-NTA chelate (e.g., Nickel NTA, Copper NTA, Iron NTA, Cobalt NTA, Zinc NTA), metal-IDA chelate (e.g., Nickel IDA, Copper IDA, Iron IDA, Cobalt IDA) and metal-CMA (carboxymethylated aspartate) chelate (e.g., Nickel CMA, Copper CMA, Iron CMA, Cobalt CMA, Zinc CMA); glutathione surfaces—nucleotides, oligonucleotides, polynucleotides and their analogs (e.g., ATP); lectin surface-heparin surface-avidin or streptavidin surface, a peptide or peptide analog (e.g., that binds to a protease or other enzyme that acts upon polypeptides).

After the fluid sample contacts capture reagents, a washing reagent can be used to remove residual contaminants from the fluid. The washing reagent can be stored in an auxiliary chamber in fluid communication with a chamber containing capture reagents and sample. As noted elsewhere in the present disclosure, a separation unit can be modified to include additional chambers, ports and channels for accommodating auxiliary reagents and solutions. The washing reagents can be applied to the chamber for a time and in a concentration suitable for removing residual contaminants. Alternatively, a washing reagent can be applied to the chamber via a port operably associated with the chamber and connected to the outside environment. The washing reagent washes residual contaminants, such as salts, from the sample components associated with the capture reagents. A variety of suitable wash solutions of varying pH, solvent composition, and ionic strength may be used for this purpose and are well known in the art. For example, a suitable washing reagent is a solution of 80 mM potassium acetate, 8.3 mM Tris-HCl, pH 7.5, 40 uM EDTA, and 55% ethanol.

After washing, any target analyte associated with the capture reagent can be disassociated from the capture agent by application of an elution reagent. Similar to the washing reagent, the elution fluid can be stored in an auxiliary chamber or applied through a suitable port. In general, any suitable elution reagent may be used to elute, for example, nucleic acids from a capture reagent. Such elution reagents are well known in the art. For example, the elution reagent may comprise molecular grade pure water, or alternatively, a buffer solution, including but not limited to a solution of TRIS/EDTA; TRIS/acetate/EDTA, for example 4 mM Tris-acetate (pH 7.8), 0.1 mM EDTA, and 50 mM NaCl; TRIS/borate; TRIS/borate/EDTA; potassium phosphate/DMSO/glycerol; NaCl/TRIS/EDTA; NaCl/TRIS/EDTA/TWEEN; TRIS/NaCl/TWEEN; phosphate buffers; TRIS buffers; HEPES buffers; nucleic acid amplification buffers; nucleic acid hybridization buffers, etc.

Reagents for performing amplification of a nucleic acid can be included in the same chamber as the purification reagents or a different chamber. Accordingly, a reaction chamber in fluid communication with the collection chamber can include reagents suitable for amplifying a nucleic acid target analyte. Elution fluid containing a target nucleic acid can, for example, contact PCR reagents contained in a reaction chamber for PCR amplification and detection. As used herein, the term “nucleic acid” refers to any synthetic or naturally occurring nucleic acid, such as DNA or RNA, in any possible configuration, i.e., in the form of double-stranded nucleic acid, single-stranded nucleic acid, or any combination thereof. As used herein, the term “fluid sample” includes both gases and liquids, preferably the latter. The fluid sample may be an aqueous solution containing particles, cells, microorganisms, ions, or small and large molecules, such as proteins and nucleic acids, etc. In a particular use, the fluid sample may be a bodily fluid, e.g., blood or urine, or a suspension, such as pulverized food. The fluid sample may be pretreated, for example, mixed with chemicals, centrifuged, pelleted, etc., or the fluid sample may be in a raw form.

An exemplary system can use a paramagnetic object composed of a paramagnetic material free to move within a chamber. The chamber also contains a liquid with glass beads and suspended cells or viruses. Movement of the chamber relative to a magnetic field causes the paramagnetic object to move within the chamber causing mechanical shear and effecting the disruption of cells or viruses within the chamber. If the previously mentioned chamber is part of a rotating platform, then, upon completion of disruption of cells or viruses, the solution can be clarified by the use of centripetal force. Cell or viral debris that is denser than the solution can be pressed against the inner walls of the chamber within the rotor. The clarified liquid may then be transferred to collection chamber without the precipitated debris by use of a siphon eliminating the risk of recontamination of the clarified liquid by the precipitated debris.

Advantages of the apparatuses, systems and methods described herein include: 1) cell disruption without the need of chemicals; 2) distribution of disrupting energy evenly throughout a sample volume; 3) low-cost and simplicity of operation; and 4) time-efficient isolation of a target analyte from a starting biological sample.

Further objects and advantages are to provide a system for cell and virus disruption that is integrated within a centrifugal apparatus. This apparatus may be used to manipulate fluids in a way to carry out functions such as, precipitation of suspended solids, mixing, dilution, and distribution of liquids.

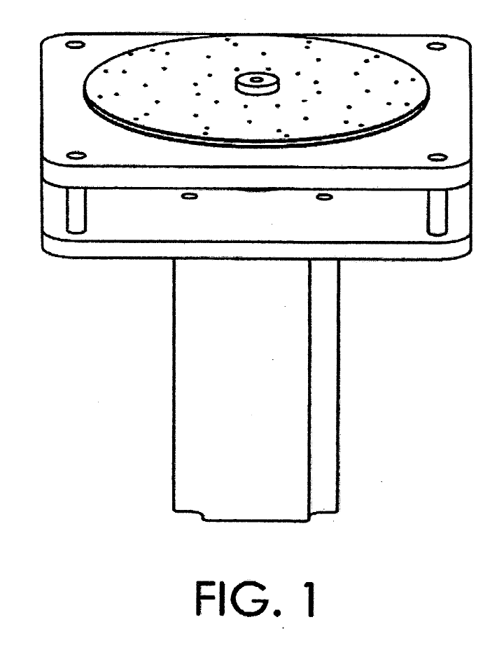

Referring to FIGS. 1-5 generally, components of the apparatus and systems provided herein include motor 10, motor mount 12, magnet holder 14, rotor 18, motor adapter 20, bottom disk 22, bottom cut adhesive 24, middle disk 26, top cut adhesive 28, top disk 30, magnet at outer radius 32A, magnet at inner radius 32B, magnetic flux lines 33, stainless steel disk 34, milling chamber 36, clarification chamber 38, constricted channel 40, capillary siphon 42, collection chamber 44, sample application port 46, sample collection port 48, ventilation port on collection chamber 50, and ventilation port on clarification chamber 52.

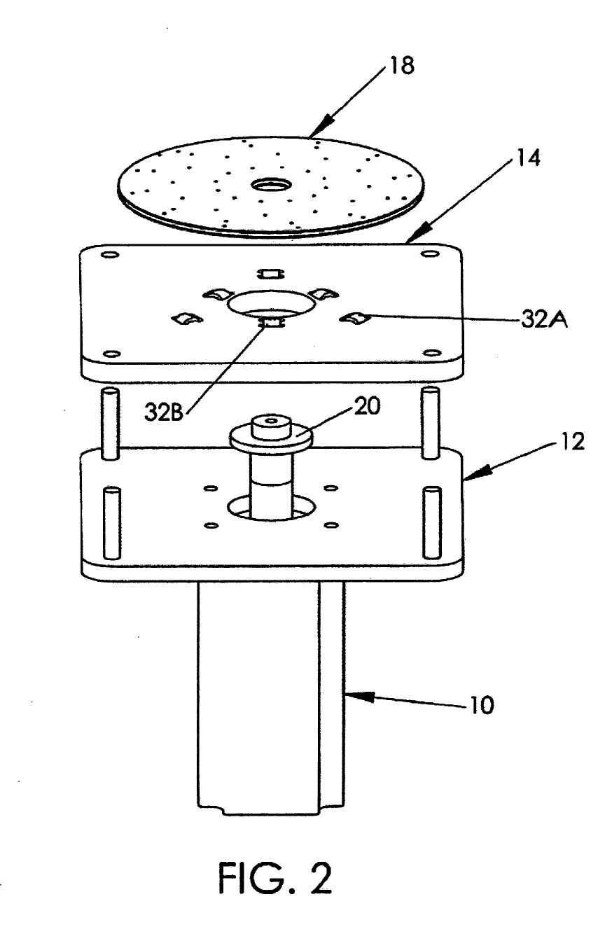

Referring to FIG. 1, the apparatus and systems provided herein are designed for use in milling/purification methods as described below. FIG. 2 is an expanded view of the previously mentioned apparatus. Motor 10 has an adapter 20 fixed to its shaft for rotating the rotor 18. Attached to the housing of motor 10 is the motor mount 12 to which the magnet holder 14 is fixed. Two sets of identical cylindrical permanent magnets (each about 9.5 millimeters diameter by about 6.5 millimeters high) are immobilized on the magnet holder 14. Three magnets 32A are distributed about 120 degrees apart around the axis of rotation of the shaft of motor 10 with the centers of the magnets at the same radius of 38.3 millimeters. Offset by about 60 degrees from each magnet 32A is a magnet 32B. The centers of the magnets 32B are at the same radius of about 23.9 millimeters. When the milling/purification apparatus is assembled, the motor 10 rotates the rotor 18. The bottom of rotor 18 is about 1 millimeter above the crests of magnets 32A and 32B.

Referring to FIG. 3, rotor 18 can be a concentric assembly of multiple components, each of which can be disk-shaped and about 120 millimeters in diameter with a center hole about 15 millimeters in diameter. The bottom polycarbonate disk 22 is about 0.6 millimeters thick and it is bonded to polycarbonate center disk 26 (about 0.2 millimeters thick) by means of a cut film of transfer adhesive 24 (about 0.1 millimeters thick). The center disk 26 has cut-thru features machined with a computer numerical controlled (CNC) milling machine and it is bonded to polycarbonate top disk 30 (about 0.6 millimeters thick) by means of the cut film of transfer adhesive 28 (about 0.1 millimeters thick). The function of cut film transfer adhesive 28 is not only to bond disks 26 and 30 together, but to define fluidic channels as well. The multiple perforations in top disk 30 are all 1 millimeter in diameter, drilled with a CNC machine. Before final assembly of rotor 18, the surface energy of the component disks can be increased to make inner surfaces of the rotor easier to wet. For this milling/purification apparatus, oxygen plasma was used to treat the surfaces of the components before final assembly.

The magnets 32A and 32B can be arranged on magnet holder 14 to produce a magnetic field with a triangular shape (FIG. 4). The complimentary ends of the magnets (N and S) face each other to produce interconnecting flux lines 33.

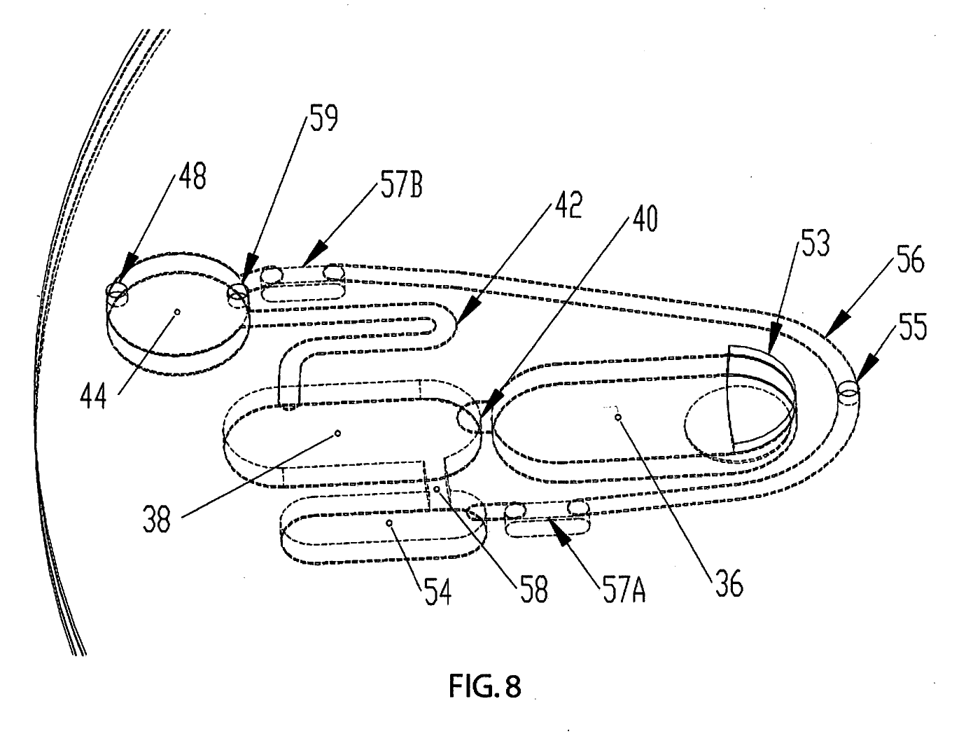

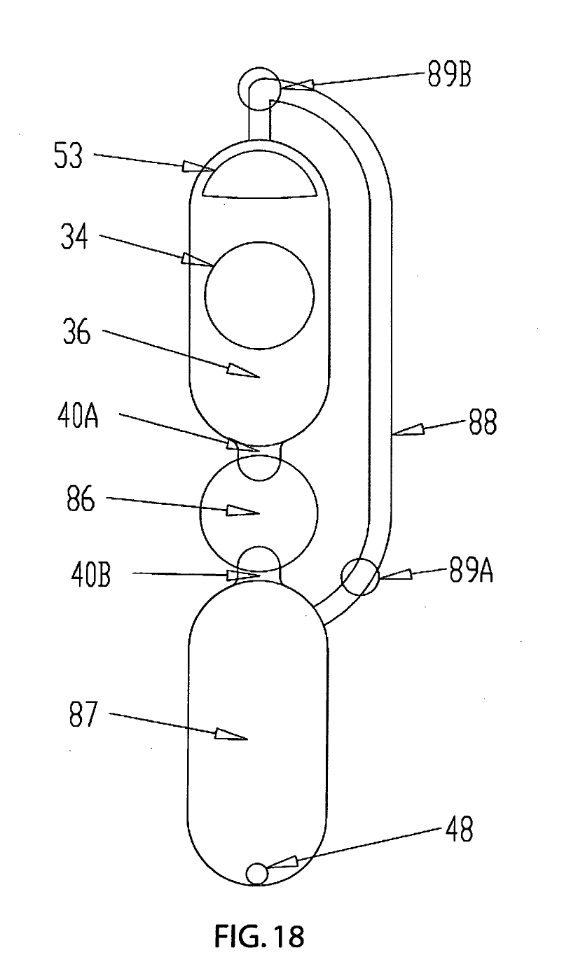

Referring to FIG. 5, a transparent representation of a section of rotor 18 rotating over the stationary magnet holder 14 is provided. In operation, a fluid sample containing a desired analyte. e.g. nucleic acid, is added to the inlet port 46 of the milling chamber 36. The cells, spores, or microorganisms present in the fluid sample begin to be lysed by the action of the paramagnetic object 36. The lysed sample proceeds from the milling chamber 36 through constriction channel 40 optionally passing through a filter (see FIG. 18, element 86). The lysed sample flow through channel 40 and in to clarification chamber 38 optionally containing capture reagents. Clarification chamber is optionally associated with a waste chamber (see FIG. 8, element 54). In another embodiment, the lysed sample fluid may be redirected to circulate through collection chamber 44 and/or a reaction chamber, each of which can optionally contain capture reagents and/or amplification reagents suitable for isolating and/or amplifying a target analyte.

As can be appreciated from FIG. 5, rotor 18 includes multiple independent separation units. Each separation unit can include a plurality of chambers. The exemplary separation units depicted in FIG. 5 are composed of 3 separate chambers: the milling chamber 36, the clarification chamber 38, and the collection chamber 44. Before final assembly of rotor 18, metal disk 34 comprised of, for example, stainless steel is placed inside chamber 36 along with about 50 milligrams of glass beads (about 100 micrometer mean diameter) not shown. As rotor 18 rotates over the fixed magnets, the metal disks 34 are attracted to the magnets 32A and 32B. At intermediate angular positions between magnets 32A and 32B, the metal disks 34 travel along the interconnecting magnetic flux lines between the magnets. At constant rotation of about 200 revolutions per minute (RPM), the metal disks 34 oscillate in a radial fashion within the milling chamber 36. The flat metal disks 34 glide across the bottom flat wall of the milling chamber 36 impacting its radial extremities when it reaches angular alignment with either magnets 32A or 32B. Both of these actions cause mechanical shear that is enhanced by the presence of glass beads and can be used to disrupt cells or viruses.

The inlet port 46 allows the application of a liquid sample containing either cells or viruses into the milling chamber 36. Upon completion of the milling step, the liquid containing the contents of the disrupted cells or viruses may then be transferred to the clarification chamber 38 via constricted channel 40. In this chamber, a high-speed centrifugation will cause any cell/virus debris or glass beads to press down at the wall of the clarification chamber 38 closest to the edge of the rotor 18. As a result, the liquid in this chamber will be “clarified”. When the liquid is clear, the rotation rate of rotor 18 can then be slowed to allow priming of capillary siphon 42. In the presence of low surface energy (high contact angle), the siphon will not prime. After priming, the rotation rate of rotor 18 and then be increased to cause the siphon to transfer any liquid within clarification chamber 38 at a lower radius than the intake of siphon 42 to be transferred to the collection chamber 44. Collection port 48 can be sealed with a removable seal to prevent the clarified liquid to escape through it. The ventilation port 52 can allow the intake of air to replace the liquid removed from clarification chamber 38. Ventilation port 50 can allow air to escape from collection chamber 44 to compensate for the incoming clarified liquid entering it via siphon 42. The seal over collection port 48 can be removed and the clarified liquid with the contents of disrupted cells or viruses can be aspirated out through that port.

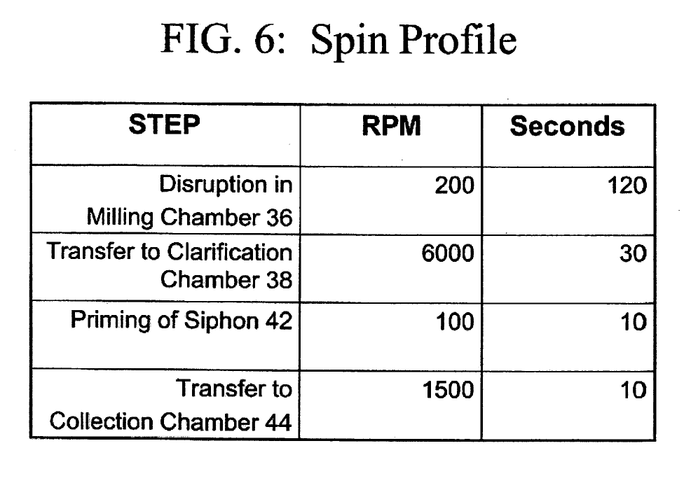

In one exemplary embodiment, a separation unit can be divided into multiple sections including 1) a milling chamber 36 using a metal disk 34 and glass beads; 2) a clarification chamber 38 using centrifugal force; and 3) a collection chamber 44 for storing the clarified liquid. In the milling chamber 36, the metal disk 34 and glass beads can be preloaded so that the user only has to add sample through the inlet port and seal it with adhesive film. Slow rotation at about 200 RPM of the rotor 18 through magnetic field of magnet holder 14 with magnets 32A and 32 B can cause the metal disk 34 to oscillate radially. An exemplary period of time for oscillation can be about 120 seconds (FIG. 6). This movement can effect the disruption of cells by the metal disk 34. The optional inclusion of glass beads can further enhance the shearing action of the oscillating disk. After this step the disk can then be spun at a fast rotational speed of 6000 RPM for 30 seconds to force the liquid in the milling chamber 36 to pass through a constricted channel 40 into the clarification chamber 38. The constricted channel 40 will hold back most of the glass beads and cell/virus debris in the milling chamber 36. The high rate of rotation will cause any cell/virus debris and glass beads that make it into the clarification chamber 38 to be pressed into a pellet at the bottom of the chamber. After clarification of the liquid, the rate of rotation can be reduced to, for example, 100 RPM for about 10 seconds to allow the capillary siphon 42 to fill with liquid by capillary wicking. Once the siphon 42 has been filled, the rate of rotation can be increased to, for example, 1500 RPM for about 10 seconds to transfer the clarified liquid from the clarification chamber 38 into the collection chamber 44 through the siphon 42. Optionally, rotor 18 can then be stopped and the clarified liquid can be removed via collection port 48.

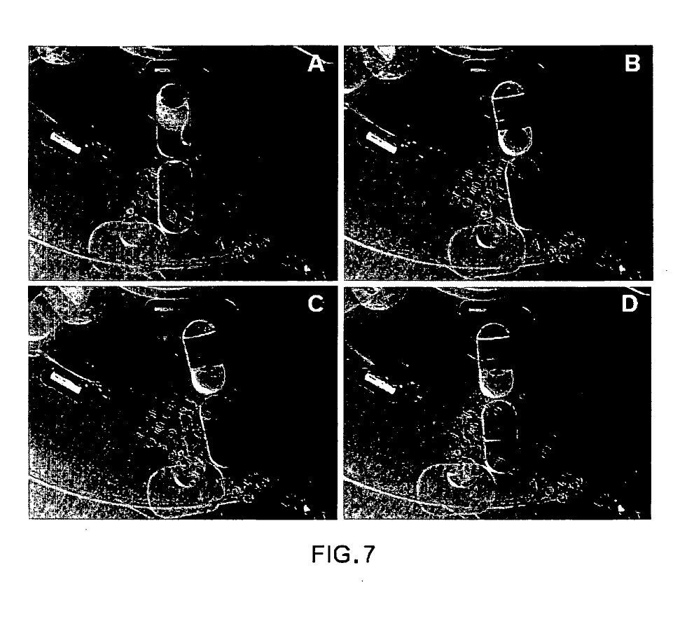

Referring to FIG. 7, panels A, B, C and D depict an exemplary apparatus and system as described in the present disclosure. Referring to FIG. 8, additional embodiments of an apparatus described herein can include larger application port(s) 53 that accommodate larger sample dispensers. As the sample is applied, air inside the system can escape from ventilation channel 56 via capillary valves 57A and/or 58B, and eventually through ventilation port 55. Capillary valves 57A and 57B are examples of fluidic features that can prevent the flow of a liquid by increasing the angle of contact between the surface of a liquid and the wall of a container. During loading and processing of the sample, ports 48 and 58 can be optionally sealed by, for example, a water resistant adhesive film. After loading of the sample, both ports 53 and 55 can be sealed to prevent the formation of undesired aerosol during processing. The sample can be lysed in chamber 36 and then transferred through channel 40 into the clarification chamber 38. Sample volume that exceeds a specified limit can overflow via channel 58 into waste chamber 54 during the clarification step. After the centrifugation step, the clarified liquid containing a target analyte can be transferred to the collection chamber 44 by way of siphon 42. The liquid entering the collection chamber 44 displaces air through capillary valve 57B, through the ventilation channel 56, entering the overflow waste chamber 54 through capillary valve 57A. Overflow waste chamber 54 can be fluidly associated with channel 58 and clarification chamber 38. Once in the collection chamber, the liquid may be removed via port 48 with ventilation port 59 allowing air to come into the disk to replace clarified liquid being removed.

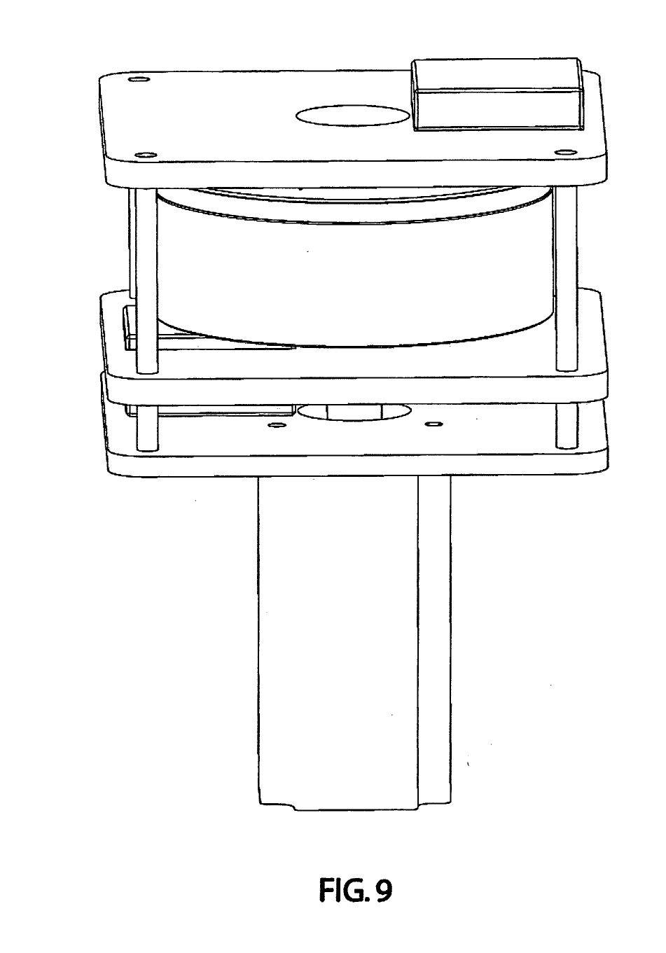

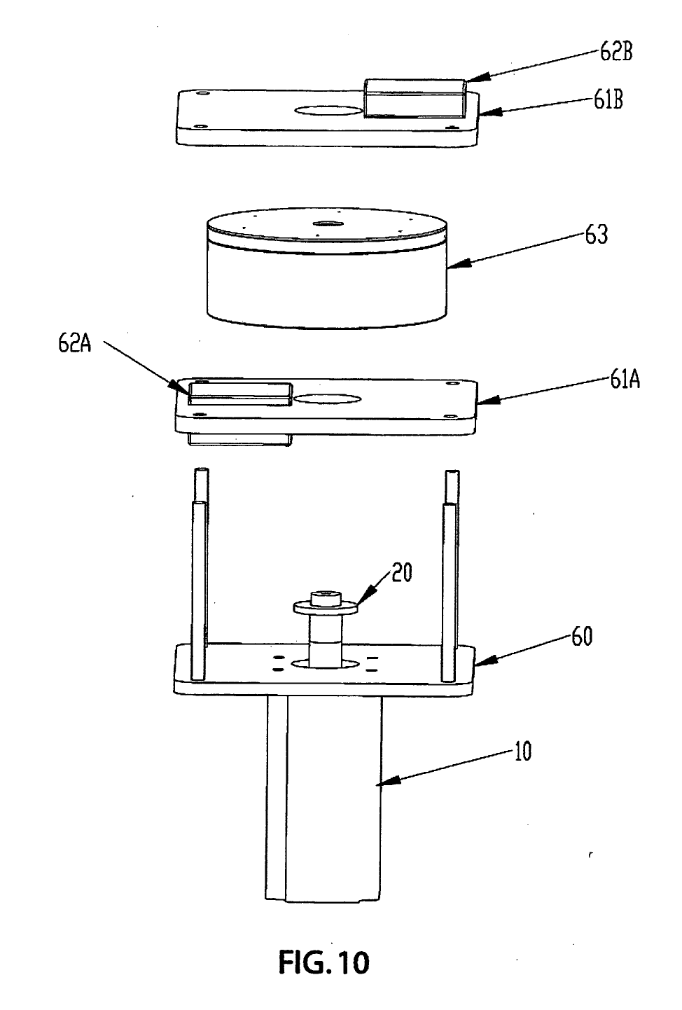

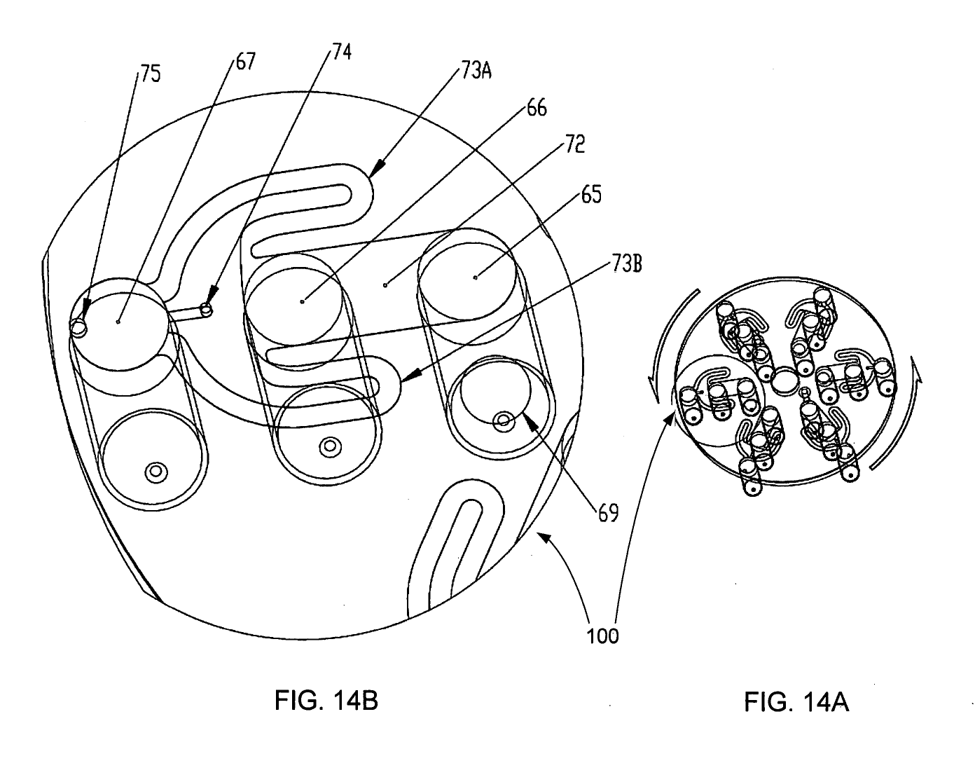

Referring to FIG. 9 and FIG. 10, an apparatus and system that can accommodate even larger sample volumes is provided. Referring specifically to FIG. 10, the components of such an apparatus and system can include motor 10, motor mount 60, motor adapter 20, magnet holders 61A and 61B, magnets 62A and 62B, and rotor assembly 63. Referring to FIG. 11, an expanded of rotor assembly 63 is provided. Rotor 64 provides support to the array of vertically elongated chambers 65, 66, and 67 of insert 68 during rotation. A paramagnetic object 69 (e.g., a ball bearing) can reside in each chamber 65. A patterned layer 70 defines fluidic channels and associates insert 68 with cover 71. The patterned layer 70 is shown in greater detail in FIG. 14A and FIG. 14B. It is understood that patterned layer 70 is functionally associated with vertically elongated chambers 65, 66, and 67 of insert 68. It is also understood that the association of the patterned layer with a vertically elongated chamber represents a separation unit 100 as shown in FIG. 14A and FIG. 14B. As previously noted, an apparatus includes at least one separation unit 100 operably associated with a platform. Additional exemplary separation units 100 are depicted in FIG. 8 and in FIG. 18. In general, a platform provides structures suitable for the association of multiple separation units. A platform provides a base structure from which at least one, and optionally multiple, separation units are disposed. Exemplary platforms are shown in FIG. 3 and FIG. 11. With regard to FIG. 11, the platform includes rotor 64, insert 68, patterned layer 70, and cover 71. Patterned layer 70 delineates multiple separation units in the x and y dimension. However, it is understood that the chambers included in insert 68 (e.g., chambers 65, 66 and 67) are operably associated with, and considered part of, their respective separation units.

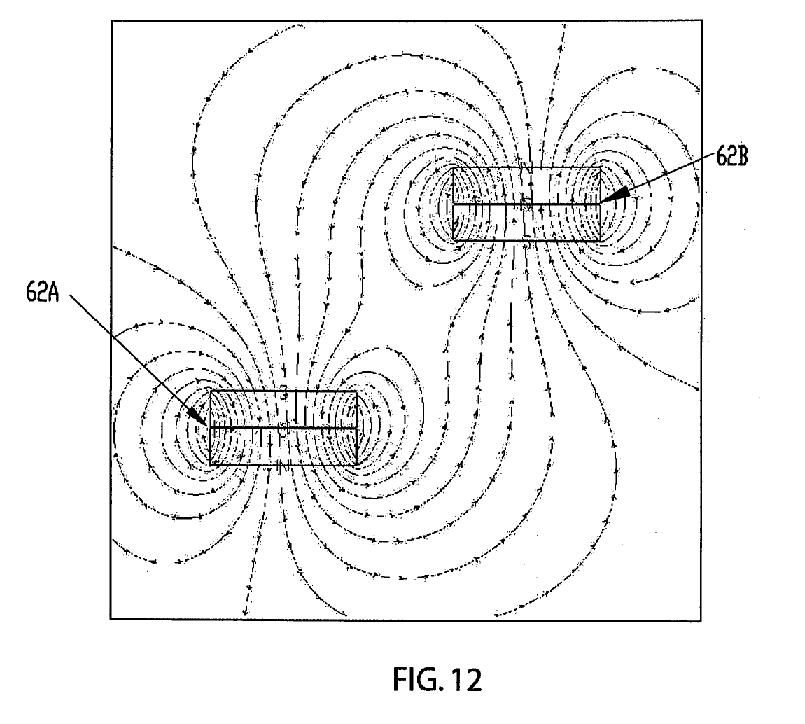

A model of an exemplary magnetic field generated by magnets 62A and 62B is presented in FIG. 12. The magnetic lines flow from one magnet to the other. The position, size and number of magnets can be modified to accommodate a configuration of an apparatus provided herein. Accordingly, the magnetic field depicted in FIG. 12 can be altered in accordance with the position, size and number of magnets associated with a particular configuration of an apparatus provided herein.

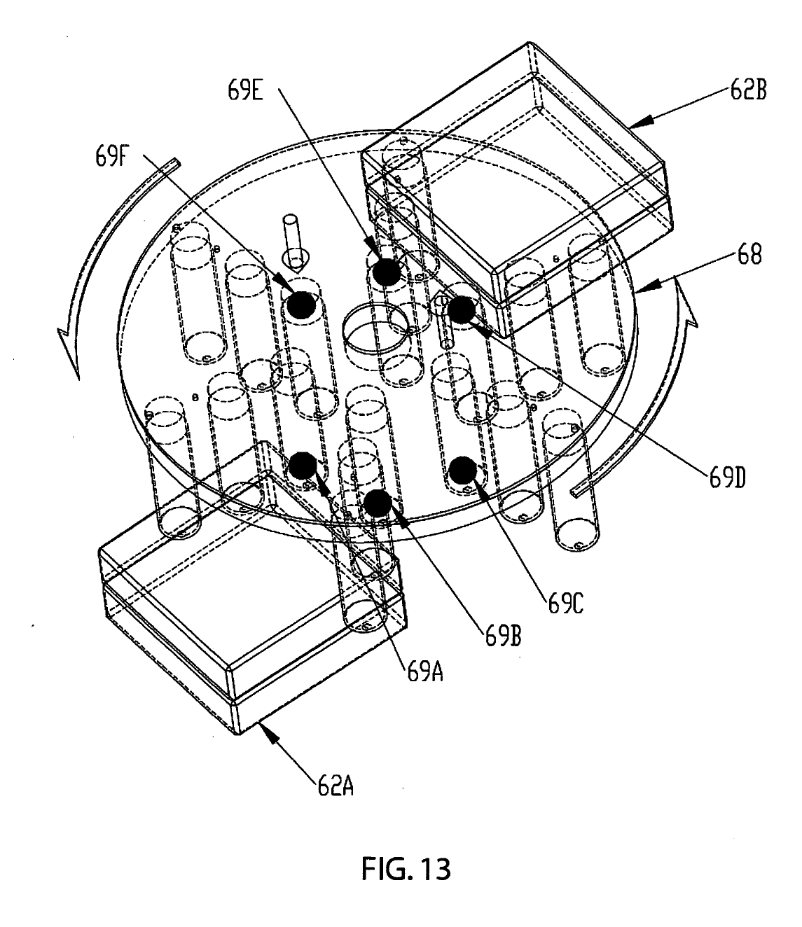

Referring to FIG. 13, the paramagnetic objects translocate inside the array of chamber 65 of insert 68 as it rotates. Paramagnetic objects 69A and 69B are attracted towards the bottoms of their respective chambers by magnet 62A. Paramagnetic objects 69D and 69E are attracted towards the tops of their respective chambers by magnet 62B. As insert 68 rotates clockwise, paramagnetic object 69C will be attracted to the top of is chamber while paramagnetic object 69F will be attracted towards the bottom of its chamber. The oscillations of the paramagnetic objects 69 will be vertical within chamber 65 (see FIG. 14) as induced by the vertical magnetic lines of the magnets 62 located 180 degrees apart. The sample is then transferred from chamber 65 to chamber 66 via the channel 72 by increasing the angular velocity from about 200 RPM to 6000 RPM as per the spin profile in FIG. 6. The priming of siphons 73A and 73B occurs at 100 RPM while the transfer of clear liquid from chamber 66 to chamber 67 occurs at 1500 RPM. Liquid entering chamber 67 displaces air that escapes via ventilation port 74. The prepared sample may then be removed through port 75.

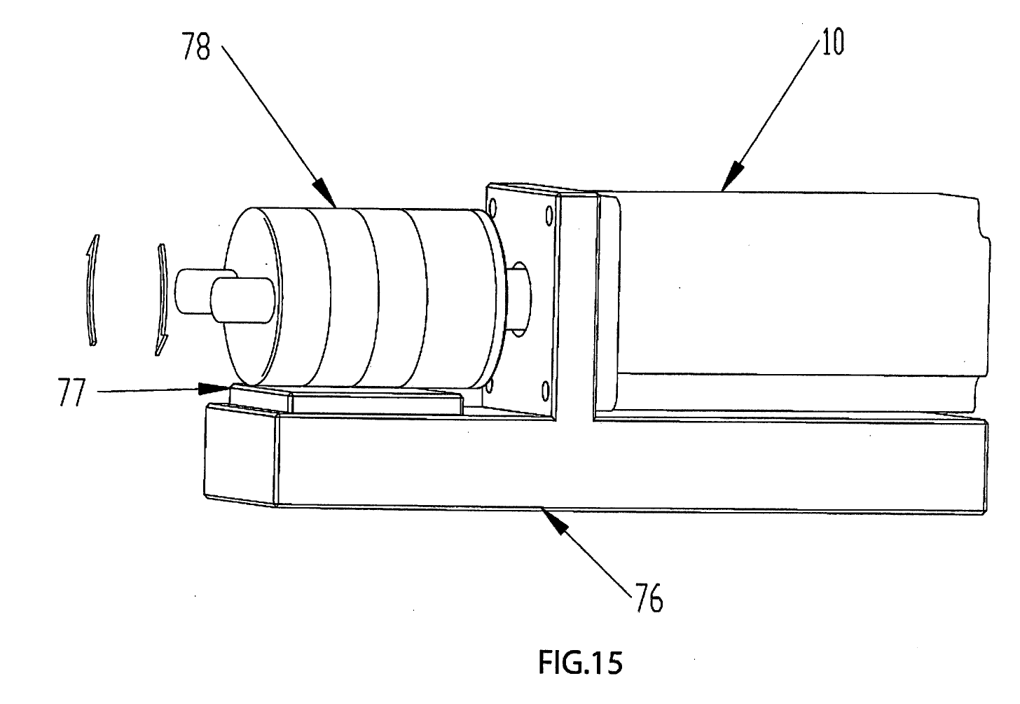

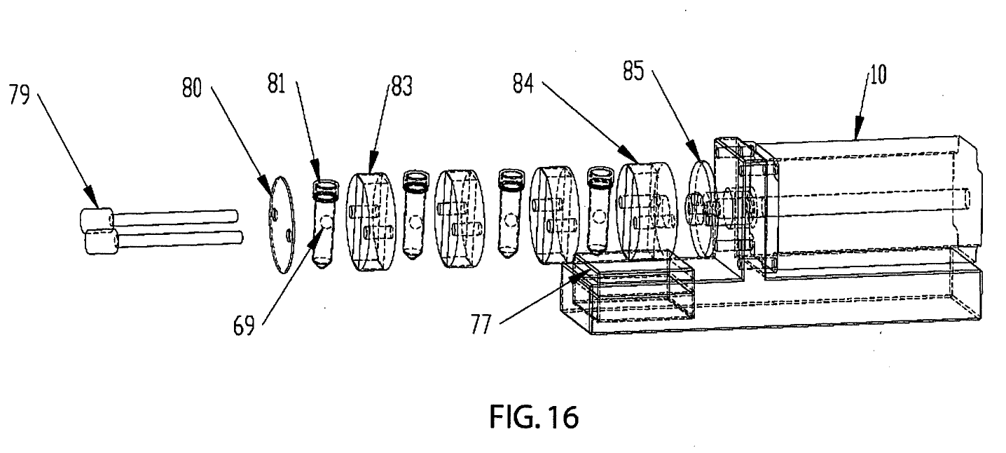

In another embodiment, an apparatus and system for facilitating sample disruption in a removable chamber, such as a microcentrifuge tube, are provided. Referring to FIG. 15, an apparatus and system for facilitating oscillations of paramagnetic objects within a removable chamber can include a motor 10, a stage 76 for holding the motor and magnet 77, and a rotor assembly 78 capable of holding multiple removable chambers. Referring to FIG. 16, the components of rotor assembly 78 can include fasteners 79 for detachably connecting an assembly including a cap retainer 80 and removable chamber adapter 83 configured to confine removable chamber 81. The assembly ends with terminal adapter 84 operably associated with motor adapter 85 which is operably associated with motor 10. Rotor assembly 78 can then be rotated over a stationary magnetic field emanating from magnet 77.

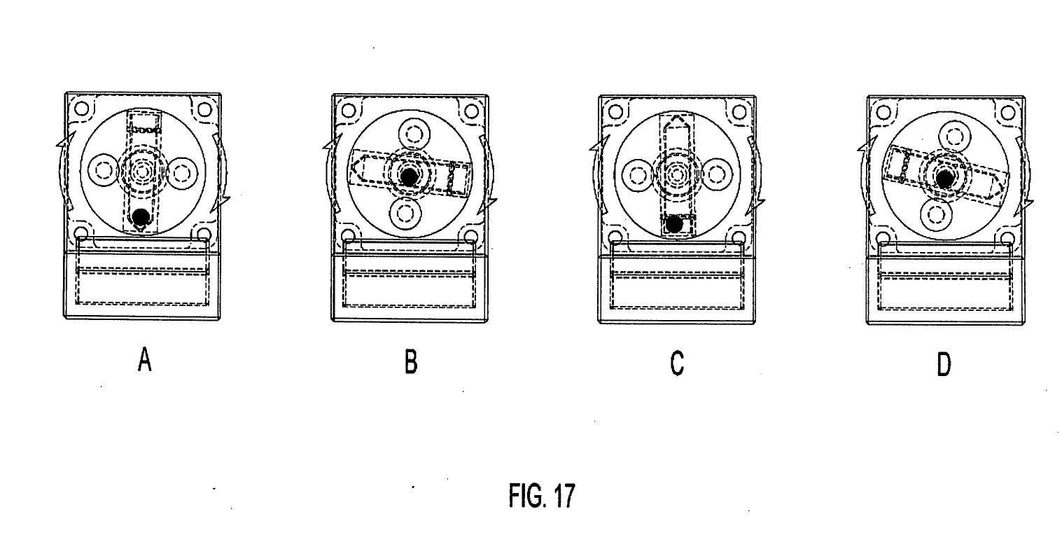

Referring to FIG. 17, the paramagnetic object oscillates within the removable chamber as the rotor assembly 78 rotates. FIG. 17, panel A depicts the stable starting position with the paramagnetic object at its closest point to the magnet. As the rotation takes place, the paramagnetic object travels within the removable chamber towards the magnet (see FIG. 17, panel B). FIG. 17, panel C depicts a second stable position 180 degrees from starting point in FIG. 17, panel A. The paramagnetic object is in motion again in FIG. 17, panel D as the rotor approaches the starting angular position of FIG. 17, panel A.

As previously noted, any connection or transfer channel that operates to facilitate the movement of a fluid between chambers associated with a separation unit can include a filter. Referring to FIG. 18, an exemplary in-line filter can be associated with the transfer channel between two chambers. The sample is applied to the chamber 36 through the sample application port 53. Ports 53 and 48 can be sealed with adhesive film during operation of the system. Rotational movement of the simplified system relative to a magnetic field at about 200 RPM will cause the paramagnetic object 34 to oscillate radially within chamber 36. After processing of the sample, rotational speed can be increased to facilitate the transfer of the supernatant of through filter 86 to the next chamber. Solid materials that pass through channel 40A will be retained by filter 86 and only liquid and particles smaller than the mean cutoff pore diameter of the filter will travel via channel 40B in the collection chamber 87. Air displaced by the liquid entering chamber 87 will travel via ventilation channel 88 into chamber 36. Capillary valves 89A and 89B will keep liquids in chambers 87 and 36 from spontaneously entering ventilation channel 88. The filtered liquid can then be removed via collection port 48.

In some embodiments, it may be desirable to place certain samples, such as tissue biopsy material, soil, feces, exudates, and other complex material into the milling chamber described herein so as to effect extraction of a target analyte from the sample. The mechanical action associated with the translocatable member facilitates the process of extraction by mixing the sample.

The apparatus provided herein is particularly well adapted for automated introduction of a sample in to a separation unit associated with an apparatus. With certain samples, such as those presenting a risk of hazard to the operator or the environment, such as human retrovirus pathogens, the transfer of the sample to the unit may pose a risk. Thus, in one embodiment, a syringe may be integrated into a apparatus to provide a means for moving external fluidic samples directly into the unit. Alternatively, a venous puncture needle and an evacuated blood tube can be attached to the unit forming an assembly that can be used to acquire a sample of blood. After collection, the tube and needle are removed and discarded, and the unit is then placed in an instrument to effect processing. The advantage of such an approach is that the operator or the environment is not exposed to pathogens.

Accordingly, an apparatus provided herein can be used in diagnostic applications for the preparation and analysis of samples of human and animal origin. Such applications include the diagnosis of a disease or condition, the diagnosis of susceptibility or resistance to a disease or condition, or a choice of treatment of a disease or condition, the determination of genetic traits for any purposes. Thus, sample volumes needed to detect infectious disease analytes would be larger than those required for detecting analytes present in higher concentrations, as in most clinical and immunochemistry assays. In addition, in the case of more concentrated analytes, such as those in immunoassays and clinical chemistry assays, a large volume sample provides more options for choosing less sensitive detection means, as well as the ability to divide the sample and detect multiple analytes.

In addition, apparatuses and methods provided herein have bio-security applications. Analysis of a sample from any source for the purpose of detecting the presence (or absence) or amount of a bacterium, fungus, virus or parasite released as a bioweapon is encompassed by the apparatuses and methods disclosed herein. Samples obtained from humans or animals may be analyzed for this purpose only, and this field specifically excludes analysis of a sample from an individual human or animal for any other purpose, including but not limited to in vitro diagnostics for the treatment of the individual human or animal.

Apparatuses and methods provided herein have forensic and human identity applications. This includes the sample preparation for forensic analysis of human genetic material for use in, or in preparation for, legal proceedings, including parentage determination, excluding tissue typing.

Additional applications for apparatuses and methods provided herein include environmental testing applications. This generally includes the preparation for testing and monitoring environmental samples, including, without limitation, for the purpose of detecting the presence or absence or amount of any organism or microorganism (including, without limitation, viruses and bacteria), whether living, dead or extinct, or their remains.

Additional applications for apparatuses and methods provided herein include agricultural plant applications. This includes sample preparation for diagnostic applications in plants, including, without limitation, the diagnosis of a disease or condition, the diagnosis of susceptibility or resistance to a disease or condition, or a choice of treatment of a disease or condition, the determination of genetic traits for breeding purposes, or the identification of a particular plant species.

Additional applications for apparatuses and methods provided herein include animal identity testing and positive trait breeding applications. This includes sample preparation for analysis of biological specimens for the identification of individual animals (other than humans) whether living, dead or extinct, or their remains, including, without limitation, parentage determination. “Animal Breeding Applications” shall mean the analysis of biological specimens for the determination of genetic traits in animals (other than humans) for the purpose of selective breeding of said animals. Animal Breeding Applications specifically excludes testing for disease-related traits for the purpose of treating the tested animal for that disease. This field also specifically excludes “Genetically-Modified Organism (GMO) Testing Applications” as defined below.

Additional applications for apparatuses and methods provided herein include food testing applications. This includes sample preparation for detection and/or analysis of microorganisms in food or food/samples for quality assurance and quality control purposes.

Additional applications for apparatuses and methods provided herein include GMO testing applications. This includes sample preparation for detection and/or analysis of nucleic acid sequences or proteins of: a) plants, including whole plants, seed, grain and materials (including foods) derived therefrom, and b) animals, including live animals, carcasses, meat and meat by-products, and materials derived therefrom, solely for the purpose of determining the presence of, or derivation from, Genetically-Modified Organisms. In this context, “Genetically-Modified Organism” shall mean a plant or animal in which the genetic material has been altered in a way that does not occur naturally by mating and/or natural recombination.

Additional applications for apparatuses and methods provided herein include industrial microbiology applications. This includes sample preparation for identification, enumeration nor counts of microorganisms (bacteria, fungi, viruses or parasites) in raw material sample, process control sample or finished product sample of an industrial process for the purpose of detecting the presence (or absence) or amount either of a contaminant or of an intended component, including, for example, assays for batch-to-batch consistency, conformance with specifications or purity. This field excludes testing human-derived and animal-derived samples.

Additional applications for apparatuses and methods provided herein include contract research service applications. This includes sample preparation for performance of research or development services relating to the detection and/or analysis of nucleic acid sequences under contract for the internal research and development activities of a client.

The examples set forth above are provided to give those of ordinary skill in the art a complete disclosure and description of how to make and use the embodiments of the apparatus, systems and methods of the invention, and are not intended to limit the scope of what the inventors regard as their invention. Modifications of the above-described modes for carrying out the invention that are obvious to persons of skill in the art are intended to be within the scope of the following claims. All patents and publications mentioned in the specification are indicative of the levels of skill of those skilled in the art to which the invention pertains. All references cited in this disclosure are incorporated by reference to the same extent as if each reference had been incorporated by reference in its entirety individually.

A number of embodiments of the invention have been described. Nevertheless, it will be understood that various modifications may be made without departing from the spirit and scope of the invention. Accordingly, other embodiments are within the scope of the following claims.

What is claimed is:

1. An apparatus for separating components of a biological material in a fluid sample, the apparatus comprising a separation unit having:
a) an inlet for receipt of a sample;
b) a first chamber coupled to the inlet, the first chamber including at least one translocatable member that translocates in response to a fluctuating magnetic field;
c) a second chamber disposed adjacent to, and in fluidic communication with, the first chamber;
d) a third chamber adjacent to, and in fluidic communication with, the second chamber; and
e) an outlet coupled to the third chamber.

2. The apparatus of claim 1, wherein the first, second, or third chamber optionally includes a ventilation port.

3. The apparatus of claim 1, wherein the translocatable member that translocates in response to a fluctuating magnetic field is comprised of paramagnetic material.

4. The apparatus of claim 1, wherein the translocatable member that translocates in response to a fluctuating magnetic field is a disk or a sphere.

5. The apparatus of claim 1, wherein the first chamber further comprises at least one object that does not translocate in response to a fluctuating magnetic field.

6. The apparatus of claim 5, wherein the object is a bead.

7. The apparatus of claim 6; wherein the bead is a glass bead.

8. The apparatus of claim 1, wherein the first chamber and second chamber are connected by a channel.

9. The apparatus of claim 8, wherein the channel is constricted.

10. The apparatus of claim 8, wherein the channel comprises a filter.

11. The apparatus of claim 1, wherein the first chamber is a milling chamber.

12. The apparatus of claim 1, wherein the second chamber is a clarification chamber.

13. The apparatus of claim 1, wherein the third chamber is a collection chamber.

14. The apparatus of claim 1, wherein the first, second, or third chamber optionally includes at least one affinity region comprising an affinity matrix.

15. The apparatus of claim 14, wherein the at least one affinity region has an affinity to nucleic acids.

16. The apparatus of claim 1, wherein the first, second, or third chamber optionally includes reagents sufficient to amplify nucleic acids in the biological material.

17. A system comprising:
a) at least one apparatus as set forth in claim 1;
b) a mechanism operably associated with the apparatus of a), wherein the mechanism comprises an element that induces a magnetic field in proximity to the apparatus; and
c) a mechanism for periodically or continuously fluctuating the magnetic field in proximity to the apparatus.

18. The system of claim 17, wherein fluctuating the magnetic field comprises repositioning the apparatus in relation to the element that induces a magnetic field.

19. The system of claim 17, wherein fluctuating the magnetic field comprises repositioning the element that induces a magnetic field in relation to the apparatus.

20. The system of claim 17, wherein the apparatus comprises a platform comprised of multiple layers of polycarbonate material.

21. The system of claim 17, wherein the apparatus is detachably associated with the apparatus.

22. The system of claim 17, wherein the apparatus is permanently associated with the apparatus.

23. The system of claim 17, wherein the system is operably associated with a computer.

24. A method for separating components of a biological material, the method comprising:
a) introducing a sample comprising a starting biological material in to a first chamber of an apparatus, wherein the first chamber comprises at least one translocatable member that translocates in response to a fluctuating magnetic field;
b) applying a fluctuating magnetic field to the apparatus, wherein the translocatable member is repositioned in the chamber resulting in the separation of biological material in to biological components;
c) transferring at least a portion of the biological components to a second chamber of the apparatus; and
d) isolating the biological components.

25. The method of claim 24, wherein the biological material comprises cells.

26. The method of claim 24, wherein the biological material comprises viral particles.

27. The method of claim 24, wherein the biological material comprises tissue.

28. The method of claim 24, further comprising separating the biological components in to biological constituents.

29. The method of claim 24, wherein the first chamber further comprises at least one object that does not translocate in response to a fluctuating magnetic field.

30. The method of claim 29, wherein the object is a bead.

31. The apparatus of claim 30, wherein the bead is a glass bead.

32. The method of claim 24, further including applying centrifugal force to the biological components in the second chamber.

33. A system for facilitating sample disruption, the system comprising:
a) at least one removable chamber comprising a paramagnetic object, wherein the removable chamber is detachably connected to a chamber adapter configured to confine the removable chamber;
b) a mechanism for generating a stationary magnetic field; and
c) a mechanism for translocating the chamber of a) within the stationary magnetic field generated in b), wherein the mechanism is operably associated with the chamber adapter configured to confine the removable chamber.

34. The system of claim 33, wherein the removable chamber comprises a microcentrifuge tube.

35. The system of claim 33, further comprising a rotor assembly comprising fasteners configured to detachably restrain an assembly comprising the removable chamber adapter and the removable chamber.

36. The system of claim 33, further comprising a terminal adapter operably associated with a mechanism for translocating the chamber.
